(19) United States
(12) Patent Application Publication
(10) Pub. No.: US 2016/0161659 A1
(43) Pub. Date: Jun. 9, 2016

(54) DISPLAY APPARATUS

(71) Applicant: SAMSUNG ELECTRONICS CO., LTD., Suwon-si (KR)

(72) Inventors: Masaru MINAMI, Hwaseong-si (KR); Ki Hyung KANG, Suwon-si (KR)

(73) Assignee: SAMSUNG ELECTRONICS CO., LTD., Suwon-si (KR)

(21) Appl. No.: 14/834,525

(22) Filed: Aug. 25, 2015

(30) Foreign Application Priority Data
Dec. 4, 2014 (KR) 10-2014-0172858

(51) Int. Cl. F21V 8/00

(52) U.S. Cl. CPC G02B 6/009; G02B 6/0031; G02B 6/0025; G02B 6/0068; G02B 6/0088

(57) ABSTRACT

A display apparatus including a display panel and a backlight to supply light to the display panel is provided. The backlight includes a light guide plate to guide light to the display panel, at least one three dimensional light source disposed to face a side end of the light guide plate, a two dimensional light source disposed at a rear of the light guide plate, and at least one diffusion member disposed between the at least one three dimensional light source and the side end of the light guide plate.

### CROSS-REFERENCE TO RELATED APPLICATION

This application claims the benefit of Korean Patent Application No. 10-2014-0172858, filed on Dec. 4, 2014 in the Korean Intellectual Property Office, the disclosure of which is incorporated herein by reference.

### BACKGROUND

1. Field

Apparatuses consistent with exemplary embodiments relate to a display apparatus provided with a backlight unit for supplying light to a display panel.

2. Description of the Related Art

A display apparatus is an apparatus which is capable of displaying a screen, and examples of the display apparatus include a monitor and a television.

The display apparatus includes a display panel made up of a liquid crystal panel to display a screen thereon, and a backlight to supply light to the display panel.

The backlight is classified as a direct type backlight, in which a light source is disposed at a rear of a display panel to directly supply light to a rear surface of the display panel, and an edge type backlight including a light guide plate disposed at a rear of the display panel to supply light to both side edges of the light guide plate.

In addition, there is a backlight including a substrate and a light source implemented using a plurality of light emitting diodes disposed on the substrate.

### SUMMARY

Therefore, it is an aspect of exemplary embodiments to provide a backlight unit capable of reducing a bright section and a dark section.

Additional aspects of the exemplary embodiments will be set forth in part in the description which follows and, in part, will be obvious from the description, or may be learned by practice of the invention.

In accordance with an aspect of the exemplary embodiments, a display apparatus comprises a display panel and a backlight. The backlight may be configured to supply light to the display panel. The backlight may comprise a light guide plate to guide light to the display panel, at least one three dimensional light source disposed to face a side end of the light guide plate, a two dimensional light source disposed at a rear of the light guide plate, and at least one diffusion member disposed between the at least one three dimensional light source and the side end of the light guide plate.

The diffusion member may comprise a first surface facing the three dimensional light source, and a second surface facing the side end of the light guide plate.

The diffusion member may be provided in a shape of a quadrangular bar, and the first surface and the second surface may be positioned opposite to each other.

The first surface and the second surface may be positioned perpendicular to each other.

The three dimensional light source may comprise a substrate disposed to be parallel to the second surface, and a plurality of light emitting diodes disposed on the substrate to face the second surface.

The diffusion member may be formed of semitransparent material having a white color.

The backlight may comprise at least one reflective sheet which covers a space between the at least one three dimensional light source and the at least one diffusion member.

The reflective sheet may be provided in a U-shape to accommodate the three dimensional light source and the diffusion member.

Both ends of the reflective sheet may extend to cover a portion of the side end.

The at least one three dimensional light source may comprise one pair of three dimensional light sources which correspond to both side ends of the light guide plate, respectively. The at least one diffusion member may comprise one pair of diffusion members each disposed between respective ones of side ends of the light guide plate and respective ones of the pair of the three dimensional light sources.

In accordance with an aspect of the present disclosure, a display apparatus comprises a display panel and a backlight. The backlight may be disposed at a rear of the display panel to supply light to the display panel. The backlight may comprise a light guide plate disposed at a rear of the display panel, one pair of light sources disposed at both sides of the light guide plate, and one pair of diffusion members to diffuse light supplied from the one pair of light sources to be transferred to the light guide plate.

The diffusion member may be provided in a shape of a quadrangular bar, and may be provided at one side thereof with a first surface facing the light source and at the other side thereof with a second surface facing a side end of the light guide plate.

The light source may comprise a substrate disposed parallel to the second surface, and a plurality of light emitting diodes disposed on the substrate to face the second surface.

A reflective sheet may be provided in a U-shape to accommodate the light source and the diffusion member.

The light guide plate may be formed of transparent material. The display area of the display panel may be substantially the same size as the light guide plate.

As is apparent from the above, light supplied from a light source is introduced to a side end of a light guide plate after being diffused through a diffusion member, thereby preventing a dark section and a bright section from being generated at the side end of the light guide plate.

### BRIEF DESCRIPTION OF THE DRAWINGS

These and/or other aspects will become apparent and more readily appreciated from the following description of the exemplary embodiments, taken in conjunction with the accompanying drawings of which:

FIG. 1 is a perspective view illustrating a display apparatus according to the first exemplary embodiment of the present disclosure;

FIG. 2 is an exploded perspective view of a display module applied to the display apparatus according to the first exemplary embodiment of the present disclosure;

FIG. 3 is a cross-sectional view illustrating the display module applied to the display apparatus according to the first exemplary embodiment of the present disclosure;

FIG. 4 is a front side view illustrating a backlight applied to the display apparatus according to the first exemplary embodiment of the present disclosure;

FIG. 5 is a cross-sectional view illustrating an installation state of a light source and a diffusion member that are applied to the display apparatus according to the first exemplary embodiment of the present disclosure;

FIG. 6 is a cross-sectional view illustrating a display module applied to a three-dimensional display apparatus according to the second exemplary embodiment of the present disclosure; and

FIG. 7 is a cross-sectional view illustrating a display module applied to a three-dimensional display apparatus according to the third exemplary embodiment of the present disclosure.

### DETAILED DESCRIPTION

Various exemplary embodiments will now be described more fully with reference to the accompanying drawings in which some exemplary embodiments are shown. These inventive concepts may, however, be embodied in different forms and should not be construed as limited to the exemplary embodiments set forth herein. Rather, these exemplary embodiments are provided so that this disclosure is thorough and complete and fully conveys the inventive concept to those skilled in the art. In the drawings, the sizes and relative sizes of layers and regions may be exaggerated for clarity.

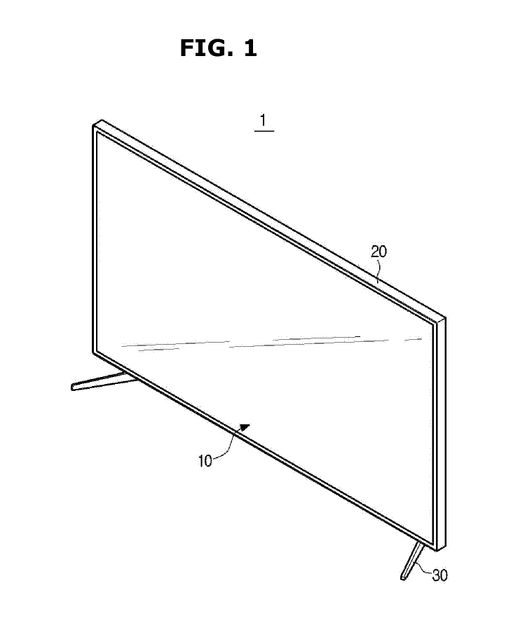

Referring to FIG. 1, a display apparatus 1 according to an exemplary embodiment of the present disclosure includes a display module 10 to display an image thereon, and a case 20 to accommodate the display module 10 while forming the external appearance of the display apparatus 1. A stand 30 is connected to a rear surface of the case 20 such that the display apparatus 1 stands in an upright position on a horizontal plane.

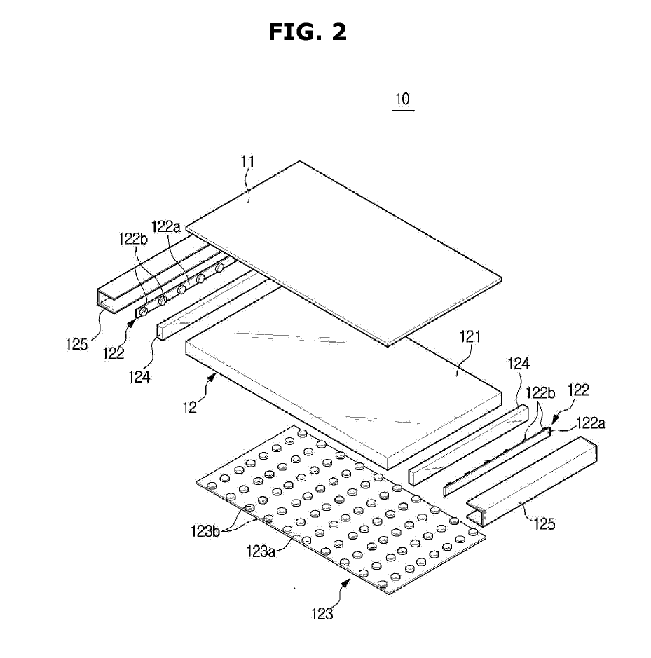

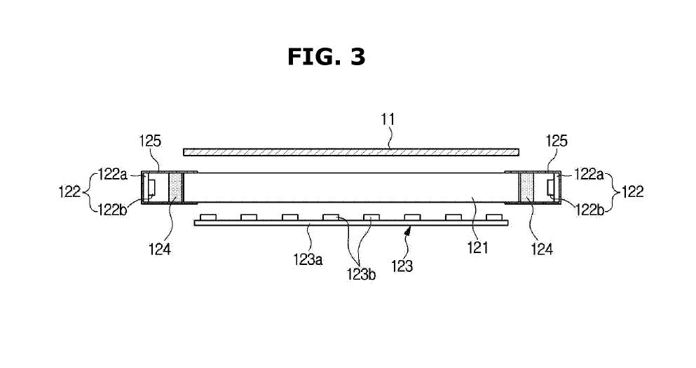

Referring to FIGS. 2 and 3, the display module 10 includes a display panel 11 to display an image thereon, and a backlight 12 to generate light and supply the generated light to the display panel 11.

The display panel 11 is made up of a liquid crystal panel having a shape of a quadrangular plate.

The backlight 12 includes a light guide plate 121 to guide light to the display panel 11, and light sources 122 and 123 to generate light.

The light guide plate 121 is formed of transparent material, and is provided in a shape of a quadrangular plate corresponding to the display panel 11 and disposed at a rear of the display panel 11. Although not shown, the light guide plate 121 may be provided with patterns allowing light to be selectively emitted from the light guide plate 121 to the display panel 11 among respective portions, so that the light guide plate 121 implements a parallax barrier function by the patterns.

The light sources 122 and 123 include three dimensional light sources 122 used to display a three dimensional image in the display apparatus 1, and a two dimensional light source 123 used to display a two dimensional image in the display apparatus 1.

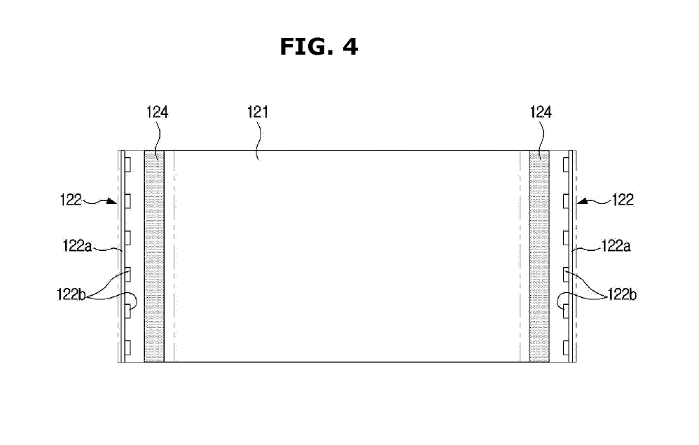

The three dimensional light sources 122 include respective substrates 122a and a plurality of respective light emitting diodes 122b disposed on the respective substrates 122a, and the two dimensional light source 123 includes a substrate 123a and a plurality of light emitting diodes 123b disposed on the substrates 123a. The substrates 122a of the three dimensional light sources 122 are disposed to be parallel to side ends of the light guide plate 122, and the light emitting diodes 122b of the three dimensional light sources 122 are disposed to face the side ends of the light guide plate 121 to irradiate light toward the side ends of the light guide plate 121. The light emitting diodes 122b are spaced apart from each other in a lengthwise direction of the substrate 122a as shown in FIG. 4. According to an exemplary embodiment of the present disclosure, the two units of the three dimensional light sources 122 are disposed at both sides of the light guide plate 121, respectively, so that light is introduced into the light guide plate 121 through both side ends of the light guide plate 121.

The substrate 123a of the two dimensional light source 123 is provided in a shape of a quadrangular plate, and disposed at a rear of the light guide plate 121 to be parallel to the light guide plate 121, and the light emitting diodes 123b are disposed on a front surface of the substrate 123a to face a rear surface of the light guide plate 121 to irradiate light toward the rear surface of the light guide plate 121.

Accordingly, light generated from the three dimensional light sources 122 are introduced into the light guide plate 121 through both side ends of the light guide plate 121, and then emitted to the display panel 11 provided at a front of the light guide plate 121. Light generated from the two dimensional light source 123 is introduced into the light guide plate 121 through the rear surface of the light guide plate 121, and then emitted to the display panel 11 by directly passing through the light guide plate 121.

As described above, the three dimensional light source 122 has the plurality of light emitting diodes 122b spaced apart from each other in a lengthwise direction of the substrate 122a as shown in FIG. 4. Through such a configuration of the light guide plate 121, a greater amount of light is transmitted to portions adjacent to the light emitting diodes 122b of the three dimension light source 122, and a smaller amount of light is transmitted to portions distant from the light emitting diodes 122b of the three dimension light source 122, so that bright sections and dark sections may be generated at the side ends of the light guide plate 121.

Accordingly, in order to prevent the bright sections and the dark sections from being generated at the light guide plate 121, the backlight 12 includes diffusion members 124 each disposed between respective ones of the three dimensional light source 122 and respective ends of the light guide plate 121.

The diffusion member 124 diffuses the light and transmits light to the light guide plate 121. According to an exemplary embodiment of the present disclosure, the diffusion member 124 is formed of semitransparent material having a white color to diffuse light. The diffusion member 124 has a shape of a quadrangular bar, and is provided in two units thereof and disposed at lateral sides of the light guide plate 121 so as to be parallel to both side ends of the light guide plate 121. A first surface provided at one side of the diffusion member 124 is disposed to face the three dimensional light source 122, and a second surface of the diffusion member 124 positioned opposite to the first surface is disposed to face the side end of the light guide plate 121. The substrate 122a of the three dimensional light source 122 is spaced apart from the first surface of the diffusion member 124 to be parallel to the first surface, and the light emitting diodes 122b of the three dimensional light source 122 are also spaced apart from the first surface of the diffusion member 124.

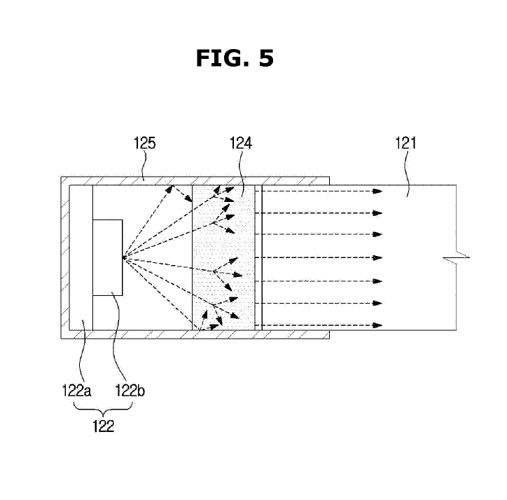

Accordingly, referring to FIG. 5, light generated from the three dimensional light source 122 is diffused in the course of being introduced into the diffusion member 124 through the first surface of the diffusion member and passing through the diffusion member 124, and the diffused light is emitted through the second surface of the diffusion member 124 and then introduced into the side end of the light guide plate 121. In this case, light generated from the light emitting diodes 122b is diffused in the course of passing through the diffusion member 124, so that light emitted from the second surface of the diffusion member 124 has a uniform distribution of light throughout the second surface. Accordingly, light having a uniform light distribution is introduced into the side ends of the light guide plate 121, thereby preventing a dark section and a bright section from being generated at the side ends of the light guide plate 121, which are adjacent to the three dimensional light sources 122.

In addition, the backlight 12 includes a reflective sheet 125 to prevent light generated from the three dimensional light source 122 from leaking. The reflective sheet 125 is provided to cover an outside of a space formed between the three dimensional light source 122 and the diffusion member 124, so that light generated from the light source 122 is entirely introduced into the diffusion member 124. According to an exemplary embodiment of the present disclosure, the reflective sheet 125 is provided in two units thereof so as to correspond to the two units of the three dimensional light sources 122 and the two units of the diffusion members 124. In addition, the reflective sheet 125 extends to cover a portion of the side end of the light guide plate 121.

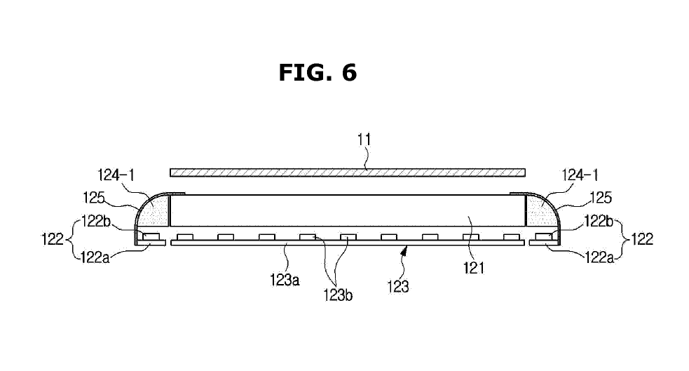

According to an exemplary embodiment of the present disclosure, the diffusion member 124 is provided in a shape of a quadrangular bar, and the first surface facing the three dimensional light source 122 and the second surface facing the side end of the light guide plate 121 are positioned opposite to each other, but the configuration of the diffusion member 124 is not limited thereto. Referring to FIG. 6, the substrate 122a of the three dimensional light source 122 may be disposed at a lateral side of the substrate 123a of the two dimensional light source 123 so that the first surface and the second surface of the diffusion member 124 may be provided perpendicular to be each other. In this case, the diffusion member 124 may have a quadrant cross-section rather than a quadrangular cross-section.

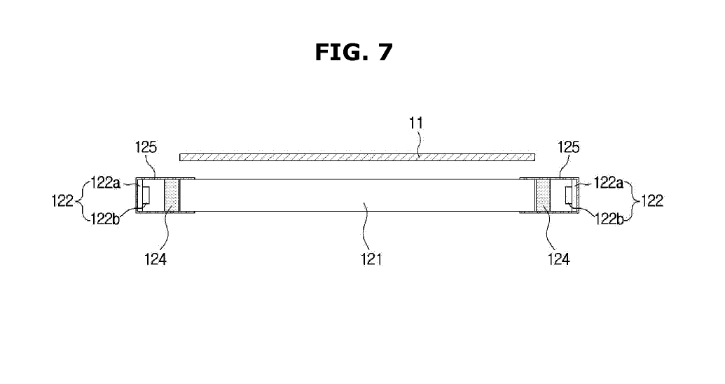

The backlight 12 according to an exemplary embodiment of the present disclosure includes the three dimensional light source 122 and the two dimensional light source 123, so that the display apparatus 1 represents a two dimensional screen and a three dimensional screen, but the present disclosure is not limited thereto. Referring to FIG. 7, the diffusion member 124 and the reflective sheet 125 may be applied to a display apparatus that displays one of the three dimensional image and the two dimensional image, for example, by only using the one pair of light sources 122 facing both side ends of the light guide plate 121, without using the two dimensional light sources 123.

Although the three dimensional light source 122 includes the substrate 122a and the light emitting diodes 122b so as to diffuse light generated from the light emitting diodes 122b, the present disclosure is not limited thereto. Even if different types of light sources are used other than the light emitting diodes 122b, the diffusion member 124 according to the present disclosure may be used such that the amount of light transmitted to the side ends of the light guide plate is uniformly distributed.

In addition, both side ends of the reflective sheet 125 according to an exemplary embodiment of the present disclosure extend to cover a portion of the side end of the light guide plate 121. Such a structure of the present disclosure is provided to cover a dark section and a bright section that may be formed at a portion of the side end of the light guide plate 121.

Since the backlight 12 including the diffusion member 124 according to the present disclosure may prevent the dark section and the bright section from being formed at the side end of the light guide plate 121, the reflective sheet 125 need not be configured to cover the side end of the light guide plate 121. In addition, such a construction enables light to be emitted through the entire front surface of the light guide plate 121, so that a display area of the display panel 11 may have the same size as that of the light guide plate 121.

In addition, although the backlight 12 according to an exemplary embodiment of the present disclosure includes one pair of the three dimensional light sources 122 which correspond to the both side ends of the light guide plate 121 and one pair of the diffusion members 124 which correspond to the both side ends of the light guide plate 121, the present disclosure is not limited thereto. For example, the backlight 12 may include one unit of the three dimensional light unit 122 corresponding to one side end of the light guide plate 121 and one unit of the diffusion member 124 corresponding to the one side end of the light guide plate 121, and may include a reflective member (not shown) disposed at the other side end of the light guide plate 121 to reflect light.

Although the patterns provided on the light guide plate 12 allow light to be selectively emitted from the light guide plate 121 to the display panel 11, the present disclosure is not limited thereto. For example, a parallax barrier or a lenticular lens may be disposed between the display panel 11 and the light guide plate 121 without having to form a configuration of the pattern.

Although a few exemplary embodiments have been shown and described, it would be appreciated by those skilled in the art that changes may be made in these exemplary embodiments without departing from the principles and spirit of the invention, the scope of which is defined in the claims and their equivalents.

What is claimed is:

1. A display apparatus comprising:
a display panel;
a backlight to supply light to the display panel, wherein the backlight comprises a light guide plate to guide light to the display panel;
at least one three dimensional light source disposed to face a side end of the light guide plate;
a two dimensional light source disposed at a rear of the light guide plate; and
at least one diffusion member disposed between the at least one three dimensional light source and the side end of the light guide plate.

2. The display apparatus of claim 1, wherein the diffusion member comprises a first surface facing the three dimensional light source, and a second surface facing the side end of the light guide plate.

3. The display apparatus of claim 2, wherein the diffusion member is provided in a shape of a quadrangular bar, and the first surface and the second surface are positioned opposite to each other.

4. The display apparatus of claim 2, wherein the first surface and the second surface are positioned perpendicular to each other.

5. The display apparatus of claim 3, wherein the three dimensional light source comprises a substrate disposed to be parallel to the second surface, and a plurality of light emitting diodes disposed on the substrate to face the second surface.

6. The display apparatus of clam 2, wherein the diffusion member is formed of semitransparent material having a white color.

7. The display apparatus of claim 1, wherein the backlight comprises at least one reflective sheet provided to cover a space between the at least one three dimensional light source and the at least one diffusion member.

8. The display apparatus of claim 7, wherein the reflective sheet is provided in a U-shape to accommodate the three dimensional light source and the diffusion member.

9. The display apparatus of claim 8, wherein both ends of the reflective sheet extend to cover a portion of the side end.

10. The display apparatus of claim 1, wherein:
the at least one three dimensional light source comprises one pair of three dimensional light sources which correspond to both side ends of the light guide plate, respectively; and
the at least one diffusion member comprises one pair of diffusion members each disposed between respective ones of side ends of the light guide plate and respective ones of the pair of the three dimensional light sources.

11. A display apparatus comprising:
a display panel; and
a backlight disposed at a rear of the display panel to supply light to the display panel,
wherein the backlight comprises a light guide plate disposed at a rear of the display panel, one pair of light sources disposed at both sides of the light guide plate, and one pair of diffusion members to diffuse light supplied from the one pair of light sources to be transferred to the light guide plate.

12. The display apparatus of claim 11, wherein one of the one pair of diffusion members is provided in a shape of a quadrangular bar, and is provided at one side of the light guide plate with a first surface facing one of the one pair of light sources and at another side of the light guide plate with a second surface facing a side end of the light guide plate.

13. The display apparatus of claim 12, wherein the light source comprises a substrate disposed parallel to the second surface, and a plurality of light emitting diodes disposed on the substrate to face the second surface.

14. The display apparatus of claim 12, wherein a reflective sheet is provided in a U-shape to accommodate the light source and the diffusion member.

15. The display apparatus of claim 1, wherein the light guide plate is formed of transparent material.

16. The display apparatus of claim 11, wherein the light guide plate is formed of transparent material.

17. The display apparatus of claim 1, wherein a display area of the display panel has substantially a same size as the light guide plate.

18. The display apparatus of claim 11, wherein a display area of the display panel has substantially a same size as the light guide plate.
